(19) United States
(12) Patent Application Publication
(10) Pub. No.: US 2010/0154172 A1
(43) Pub. Date: Jun. 24, 2010

(54) HANDLE WITH DOCKING STATION

(75) Inventor: RICHARD A. MCCOY, STEVENSVILLE, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/341,042

(22) Filed: Dec. 22, 2008

(51) Int. Cl. A47B 95/02; E05B 1/00

(52) U.S. Cl. 16/412; 16/110.1; 29/700

(57) ABSTRACT

A structure, such as an appliance, has at least one handle that is operable to open a closure. The handle on the appliance is replaced with a retrofit handle having a docking station associated therewith. A consumer electronic device (CED) is docked with the docking station for providing a service to a consumer. The retrofit handle receives power or data from an external service and the retrofit handle in turn is operable to deliver the power or data to the CED.

### TECHNICAL FIELD

This disclosure relates generally to a replacement handle for structures and, more particularly, to a retrofit handle with a docking station that replaces a previous handle, whereby the retrofit handle is operable to provide power or data.

The present application is related to the following patent applications filed concurrently herewith: U.S. Patent Application entitled Adapter Retrofit By Replacement Component bearing applicant's docket number US20070801, U.S. Patent Application entitled Replacement Handle With Power Supply bearing applicant's docket number US20070830, and U.S. Patent Application entitled Method Of Providing A Replacement Component bearing applicant's docket number US20080865.

### BACKGROUND OF THE INVENTION

Traditionally, appliances, consumer electronic devices, and other useful household machinery are located in a room dedicated to the function supported by the appliance. For example, the kitchen has traditionally been limited to a space for preparing and eating meals and consequently has been mostly occupied by cabinetry and large home appliances such as refrigerators, dishwashers, and ovens. The family room has been designated as a place for leisure activities, and so most entertainment devices, such as televisions and video games are commonly found here. Laundry rooms normally house a washer, dryer, and iron. Devices such as personal computers and printers are often located in another room, such as a dedicated home office or bedroom.

Consumers increasingly own multiple consumer electronic devices (CEDs), such as hand-held electronic devices, laptops, cell phones, PDAs, digital cameras, video recorders, and digital music players. These devices are typically used in many different rooms in the house and are often carried from room to room throughout the home. Consumers also tend to perform non-traditional tasks in the traditional rooms of the home. For example, consumers also tend to eat in the living room or media room, instead of the dining room. Consumers tend to eat, meet and entertain in the kitchen, not just the dining room and family room. In fact, the kitchen is often the hub of most household activity. Consumers also tend to work in every room of the home with the adoption of laptop computers, cellular phones, PDA's and wireless networks.

Therefore, there is a trend for consumers to perform non-traditional functions in a household room designed for a traditional function. The disclosure recognizes this trend and attempts to support the trend.

### BRIEF SUMMARY OF THE INVENTION

According to an illustration of the disclosure, a retrofit handle for a structure, such as an appliance, is provided that allows a consumer to replace an existing handle on the structure with a new handle that also provides a docking station for a consumer electronic device (CED). The retrofit handle may receive power and/or data from a proximity device which in turn is in communication with an electrical service that is external of the structure. The retrofit handle may include a docking station that is integral with the handle, or perhaps a separate component. Consumer electronic devices may receive power and/or data from the retrofit handle. A method of providing a retrofit handle with docking station is disclosed and includes the steps of removing an existing handle on a structure and then replacing the handle with a new handle that has a docking station which is operable to provide power to a CED.

### BRIEF DESCRIPTION OF THE DRAWINGS

FIG. 1A a conventional refrigerator having a handle for opening a closure;

FIG. 1B is a conventional oven having a handle for opening a closure;

FIG. 2 illustrates an appliance having an improved handle with a docking station associated therewith; and

FIG. 3 illustrates an alternative appliance having a retrofit handle with a docking station separable from the retrofit handle.

### DETAILED DESCRIPTION OF THE INVENTION

Referring now to the drawings, preferred embodiments of the present invention are shown in detail. Although the drawings represent embodiments of the present invention, the drawings are not necessarily to scale and certain features may be exaggerated to better illustrate and explain the present invention. The embodiments set forth herein are not intended to be exhaustive or otherwise limit the invention to the precise forms disclosed in the following detailed description.

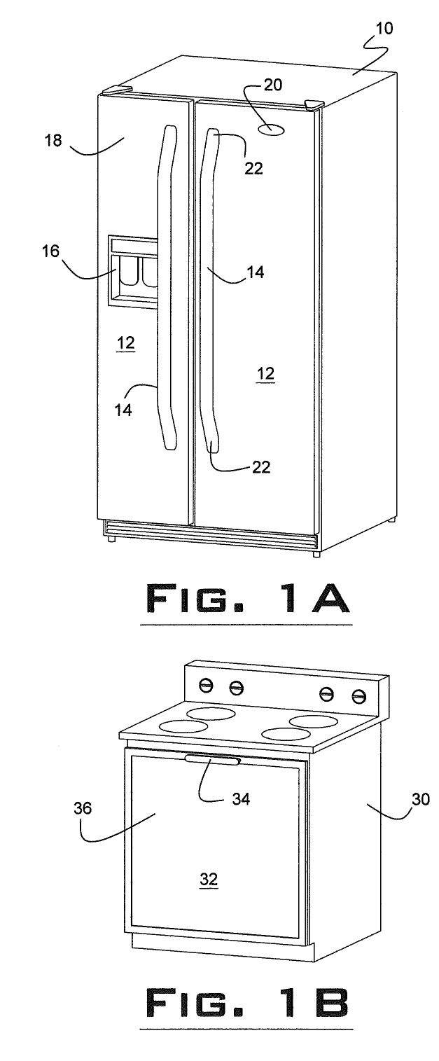

FIG. 1A is a conventional home appliance refrigerator 10 having a closure or a door 12 and handles 14. An ice dispenser 16 is located on the front surface 18 of the door 12 along with a badge 20. The handles 14 are secured to the front surface at mounting points 22 using traditional hardware. The handle allows the consumer to open the appliance 10 so as to have access to an enclosure opening.

FIG. 1B is another conventional appliance such as a stove 30. The stove 30 has a closure or door 32 for providing access to the interior of the oven. A handle 34 is secured to the front face 36 of the door 32 and provides the mechanism for the consumer to open the door 32. Both the refrigerator 10 and the stove 30 discussed above fail to provide a consumer with the ability to power a consumer electric device that may be associated with the appliance. The handles that are used with these conventional appliances further do not provide the consumer with any means of receiving power or data. Nor do these conventional handles provide the consumer with any means of mounting a CED to the handle or an appliance. Nor do these conventional handles provide a consumer with any means of interfacing with an outside power or data source.

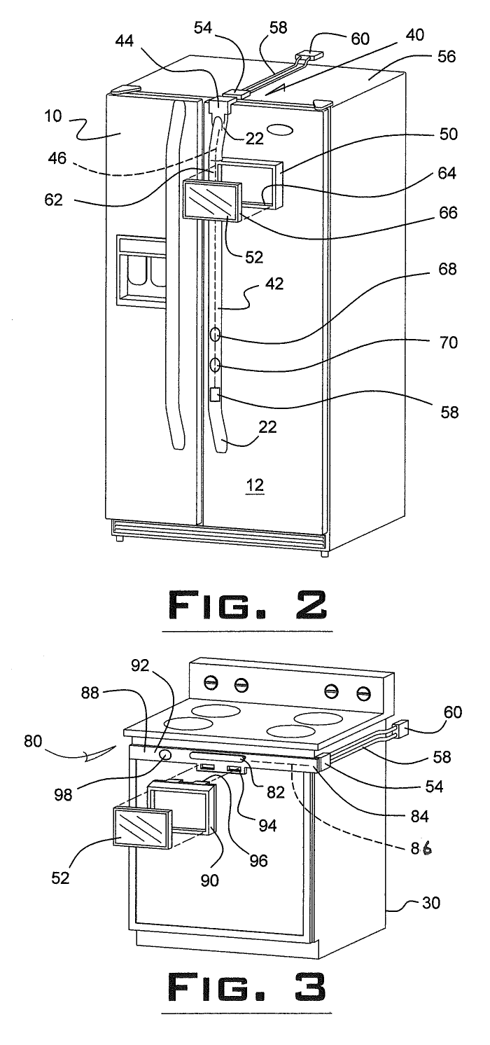

With reference to FIG. 2, a novel handle assembly 40 is disclosed in connection with an appliance, such as a refrigerator 10 as disclosed in FIG. 1A. The handle assembly 40 includes a retrofit handle 42, a proximity interface 44, a power or data pathway 46, mounting means 48, and a docking station 50. A CED 52 may be associated with the docking station 50 so as to provide the consumer with a new service not before offered with the appliance. The handle assembly 40 replaces the handle 14 disclosed in FIG. 1A. The handle 42 is secured to the front surface 18 of the door 12 at the same mounting points 22 that were used in the conventional appliance 10. Thus, the handle 14 is removed and exchanged for the entire handle assembly 40 which now provides a docking station for a consumer to integrate their CED therewith. A docking station 50 for a handle is in a location associated with a handle configured to receive a CED 52 and provide a useful function to the CED 52. Exemplary useful functions are storing the CED 52, concealing the CED 52, providing power to the CED 52, and exchanging, receiving, or providing information with or to the CED 52.

The novel handle assembly 40 provides the consumer with the initial function the prior handle 14 had, i.e., a means with which a person could open a door 12, but also additional functions such as providing a consumer with the means to operate a CED. Thus, the handle assembly 40 is operable to provide a consumer with several functions, including that of the traditional closure opening function. It will be appreciated that the present invention can be utilized with a variety of host structures, besides appliances. In addition, other examples of appliances besides those illustrated herein, include, but are not limited to, freezers, stoves, ranges, air conditioners, dehumidifiers, water heaters, furnaces, clothes washing machines, clothes drying machines, clothes refreshing machines, non-aqueous washing apparatuses, or any combination thereof.

The proximity interface 44 is located at the upper portion of the handle 42 and is an integral portion therewith. The proximity interface has a portion that extends over the top of the door 12 and is in close proximity to a proximity device 54 that in turn is secured to a top surface 56 of the appliance 10. The proximity interface 44 and the proximity device 54 communicate with one another so as to provide an electrical service, such as power or data, so as to provide communication to or from the handle assembly 40. When the door 12 is opened and thus exposing a cavity in the appliance 10, the proximity interface 44 and the proximity device 54 are disconnected thus ceasing transfer of data or power there between.

The handle assembly 40 could also include a battery 58 disposed within the handle 42. The battery may be of the rechargeable type and can provide power to the CEDs within or associated with the handle 42. The battery 58 may operate the CEDs while the proximity interface 44 and the proximity device 54 are disconnected. The battery receives its charge from the power or data pathway 46 which traverses an interior portion of the handle 42. The power or data pathway 46 may extend from the proximity interface 44 to several locations within the handle 42, such as the lower portion where the battery 58 is located for illustrative purposes only. It will be appreciated that the battery 58 may be located at other places in the handle assembly 40. Moreover the battery may be located within or associated with the CED 52. The CED could be recharged by the handle assembly 40, thus providing yet another function of the handle. The battery 58 may be used with the other handle assemblies disclosed herein.

The proximity device 54 is connected via wires 58 to an electrical service 60 that can be a separate external source of power or data. The electrical service 60 may be mounted to the appliance 10 or to another structure whereby it in turn receives power or data from another source. The electrical service 60 may also receive data from the CED 52 which in turn can be further routed to another device for further processing. While the proximity device 54 is shown being located on the upper surface 56 of the appliance 10, it will be appreciated that it may be located elsewhere on an appliance so long as it is in communication with the proximity interface 44 wherever it may be located on the appliance. Thus, it is contemplated that the present invention could be used on other appliances, structures, or hosts wherein its handle may be oriented in a manner other than the vertical orientation as depicted in this disclosure. Moreover, it is contemplated that the present invention can be used where it is desirable to replace an existing handle to a handle that now has an adapter or docking station.

The docking station 50 is an adapter that is operable to receive the CED 52. The docking station 50 has a left vertical portion 62 that is integral with a vertical portion of the handle 42. The connection between the docking station 50 and the handle 42 is sufficiently rigid so as to make the CED, once installed, firmly connected to the appliance 10. It may be desirable for a consumer to disassociate the docking station 50 from the handle 42 and/or the appliance 10. In this regard, the docking station 50 may be formed as a separate component and thus not integrally part of the handle 42. In this arrangement, mechanical fasteners or connectors could be employed so as to make the docking station 50 secure relative to the handle 42. Thus, the docking station can be removably attached to said handle 42 as desired.

The docking station 50 further has connectors 64, male or female, associated with a housing of the docking station. The connectors 64 can engage a corresponding interface 66 that is associated with the CED. This allows for power or data transmission between the docking station 50 and the CED 52. Other forms of data or power transmission can be used as a means to provide communication between the docking station 50 and CED 52. While the CED 52 is shown as being a separate component of the docking station 50, it will be appreciated that the CED 52 could be formed part of the docking station 50. It will also be appreciated that the CED could be formed as part of the handle 42 thus removing the need for a separate docking station 50. In addition, the handle 42 could have a simplified docking station that is operable to mate with a docking station that is built into an outside surface of a CED. This arrangement would allow the CED to be easily plugged into the side of the handle 42.

The handle assembly 40 could also include speakers 68 positioned within the handle 42 for providing sound. The speakers 68 are in communication with the power and data pathway 46 and receive their signal from the CED 52. The CED 52 provides power control to the speakers 68. It will be appreciated that the speakers 68 can be at other locations, for example in the docking station 50, the CED 52, or at other locations in the handle 42. Other CEDs 70 can be associated with the handle 42 besides the CED 52 that is associated with the docking station 50.

Although the CED 52 illustrated is a video device, the CED is any other consumer electronic device, such as, but not limited to, a television, a video camera, a video recorder, a personal computer, a notebook computer, a computer monitor, a video display, a keyboard, a printer, copying equipment, calculator, facsimile machine, scanner, digital storage device, wireless transceiver, an internet router, a power supply, a data recorder, an answering machine, a telephone, a cordless telephone, a video game system, a personal digital assistant, a DVD player, a VHS player, a VCR, a cassette deck, an 8 millimeter video player, a CD player, a blackberry, a portable digital video player, an MP3 player, a radio, an audio speaker, a digital picture frame, or a weather station. The CED 52 is operable to receive power and/or data from the docking station 60 which in turn receives said power or data, from the power and data pathway 46. In addition, the CED 52 is operable to transmit signals, data or other service, back to the electrical service 60 for further processing and/or dissemination. Thus, the retrofit handle assembly 40 is operable to communicate information and data in more than one direction.

FIG. 3 illustrates a stove 30 employing the novel handle and docking station assembly 80. The handle and docking station assembly 80 includes a retrofit handle 82, a proximity interface 84, a power or data pathway 86, mounting means 88, and a docking station 90. The handle and docking station assembly 80 replaces the handle 34 in the stove 30 shown in FIG. 1B. A CED 52 is positionable within the docking station 90 and receives its power and/or data from a source within the handle 82, and more particularly, from the power or data pathway 86. The CED 52 is operable to either receive, or transmit, data to the power or data pathway 86.

The handle 82 includes a handle mounting plate member 92 that extends across the front of the door 32 and is secured by mounting means to the face of the door 32. The mounting means 88 can be fasteners or the like that allow the handle mounting plate member 92 to be secured to the face of the door 32. Alternatively, the same mounting members that were used to secure the handle 34 to the door 32 as shown in FIG. 1B, could be reused to secure the handle mounting plate member 92 to the door 32. The proximity interface 84 is located at one end of the handle mounting plate member 92. The power and data pathway 86 is located within the handle mounting plate member 92 and extends from the proximity interface 84 to receptacles 94. Receptacles 94 can be formed as part of the handle mounting plate member 92 and provide a receptacle for receiving the male interface 96 that extends from the docking station 90. The receptacles 94 and the interfaces 96 provide the connectivity between the CED 52 and the power and data pathway 86.

Other CEDs 98 may be located within or relative to the handle mounting plate member 92. Each such CED 98 may be in communication with the power and data pathway 86. The CEDs may be of the type discussed above relative to the CED 52. While the CED 52 is shown relocatable relative to the docking station 90, it will be appreciated that the CED 52 could be made permanently part of the docking station 90. Likewise, the CED 52 could plug directly into the handle mounting plate member 92.

A proximity device 54 is secured to the side of the stove 30 and receives power and/or data from an electrical service 60 via wires 58 much in the same manner as discussed above. The proximity device 54 communicates with the interface 84 in the same manner discussed above relating to interface 44 and proximity device 54. Thus, power and or data disseminate from electrical service 60, through proximity device 54, through interface 84, through power and data pathway 86, through the docking station 90 and into the CED 52. Likewise, the CED is operable to transmit a signal reversely through the power and data pathway 86 and on to the electrical service 60.

A method of replacing a handle with a retrofit handle having a docking station includes the steps of removing a handle from a host; replacing the handle with a new handle assembly that has a docking station; providing power and/or data to the new handle assembly; and providing a CED that is powered by the docking station.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed as new and desired to be protected by Letters Patent of the United States is:

1. A handle for an appliance, the handle comprising:
a first portion attachable to an appliance; and
a second portion including a docking station.

2. The handle for an appliance as claimed in claim 1, further comprising a power adapter.

3. The handle for an appliance as claimed in claim 1, further comprising a rectifier.

4. The handle for an appliance as claimed in claim 1, further comprising a power converter.

5. The handle for an appliance as claimed in claim 1, further comprising a proximity interface for delivering electric service to the first portion.

6. The handle for an appliance as claimed in claim 1, further comprising one of a battery operable to provide power to said second portion and an interface for communicating power with a battery for providing power to said second portion.

7. The handle for an appliance as claimed in claim 1, wherein said first portion is a hand grip.

8. The handle for an appliance as claimed in claim 1, wherein said first portion includes a power source.

9. The handle of claim 1 wherein the docking station includes an first interface for coupling to a CED.

10. The handle of claim 1 further comprising a transmission pathway operably connected to the first interface and configured to communicate at least one of power and data with the interface.

11. The handle of claim 1 further comprising a second interface operably connected to the transmission pathway wherein the second interface is configured to receive at least one of power and data from a source.

12. A handle for a member that covers an enclosure opening, the handle comprising:
a hand portion connected to an enclosure opening;
a pathway for transmitting at least one of data and power within said hand portion; and
a device operable to receive at least one of data and power from said pathway.

13. The handle as claimed in claim 12, wherein said device is a consumer electronic device.

14. The handle as claimed in claim 12, wherein said device is an adapter for receiving a consumer electronic component.

15. The handle as claimed in claim 12, wherein said data transmission pathway is at least one wire for transporting an electrical signal.

16. The handle as claimed in claim 12, wherein said device includes a connector for receiving a consumer electronic device.

17. The handle as claimed in claim 12, further comprising a proximity device operable to deliver an electrical signal to said hand portion.

18. The handle as claimed in claim 12, further comprising an electrical service in communication with said hand portion.

19. The handle as claimed in claim 12, wherein said device includes a receiver, said receiver is operable to deliver data to said data transmission pathway.

20. The handle as claimed in claim 12, wherein said device includes a display screen for displaying images.

21. The handle as claimed in claim 12, wherein said device includes at least one of an audio output jack, an audio input jack, and a speaker.

22. The handle as claimed in claim 12, wherein the handle further comprises at least one coupling point for attaching the handle to the member.

23. The handle as claimed in claim 12, wherein the transmission pathway is configured for audio and video transmission.

24. The handle as claimed in claim 12, further comprising an interface for connecting the transmission pathway to a source of transmission signal.

25. The handle as claimed in claim 12, further comprising a holder portion for holding the device wherein when the device is engaged with the holder, the device can receive at least one of data and power from the pathway.

26. An appliance comprising:
a front door having a surface;
a hand member connected to the front door;
a power source in communication with the hand member; and
an interface in communication with the hand member, the interface operable to receive a device that provides information to a consumer.

27. The appliance as claimed in claim 26, wherein the device includes a connector, said device can be removed from said interface and repositioned back within said interface, said device receives power from said power source.

28. The appliance as claimed in claim 26, wherein said device is at least one of an audio and video device.

29. The appliance as claimed in claim 26, wherein said power source is within said hand member.

30. A kit for replacing a handle for an appliance with a new handle having new functionality associated with an electronic device, the kit comprising:
a new handle having a first portion attachable to an appliance, and a second portion including a docking station for an electronic device; and
instructions for installing the new handle onto the appliance.
